(19) United States
(12) Patent Application Publication
(10) Pub. No.: US 2012/0124935 A1
(43) Pub. Date: May 24, 2012

(54) Beauty brick faux brick facade

(76) Inventor: Mark Emanuele, Gardena, CA (US)

(21) Appl. No.: 12/927,786

(22) Filed: Nov. 23, 2010

(51) Int. Cl. E04G 23/00; B44C 1/18; E04C 2/30; E04F 13/072; E04F 13/16

(52) U.S. Cl. 52/746.12; 428/169; 428/141

(57) ABSTRACT

This present invention provides faux brick facades configured to cover existing brick walls, such as those that serve as fencing or property barriers. The Beauty Brick line consists of square-shaped sheets comprised of a fiberglass and plastic material that can be applied directly to the surface of bricks, and is available in a wide array of sizes. Other attributes of the Beauty Brick sheets include a pliability that accommodates facades that are curved or angled. Additionally, the sheets easily cut to size by the end user. The back of each Beauty Brick sheet features a durable adhesive material that adheres easily to the existing brick surface.

### FIELD OF THE INVENTION

The present invention pertains to the field of decorative siding, and more specifically to the field of simulated decorative brick work, such as brick panels.

### BACKGROUND OF THE INVENTION

The prior art has put forth several designs for simulated brick panels. Among these are:

U.S. Pat. No. 3,740,910 to L. James Taylor and Charles E. Nichols describes simulated brick panels that can be applied to any type of building structure to give the appearance of full-size masonry construction comprising a dense backing sheet coated with a uniform layer of water-impermeable epoxy resin adhesive and faced with several coursed of thin facing slabs.

U.S. Pat. No. 4,079,554 to Bruce J. Terwilliger describes a simulated exterior surface assembly for creating the appearance of brick, stone, or the like comprising plastic vinyl sections incorporating peel-away self-adhesive.

U.S. Pat. No. 4,313,775 to Luther L. Moore describes a simulated brick decorative surface constructed from specially shaped and cut sections of wood.

None of these prior art references describe the present invention.

### SUMMARY OF THE INVENTION

It is an object of the present invention to provide specially designed, faux brick facades configured to cover existing brick walls simple and inexpensively to improve the appearance of existing brick.

### BRIEF DESCRIPTION OF THE DRAWINGS

FIG. 1 is a view of the device of the present invention mounted on an existing wall.

FIG. 2 is a view of the device of the present invention configured in a pattern and illustrating a sample texture.

FIG. 3 is an obverse view of the device of the present invention and its removable covering which protects the adhesive backing until installation.

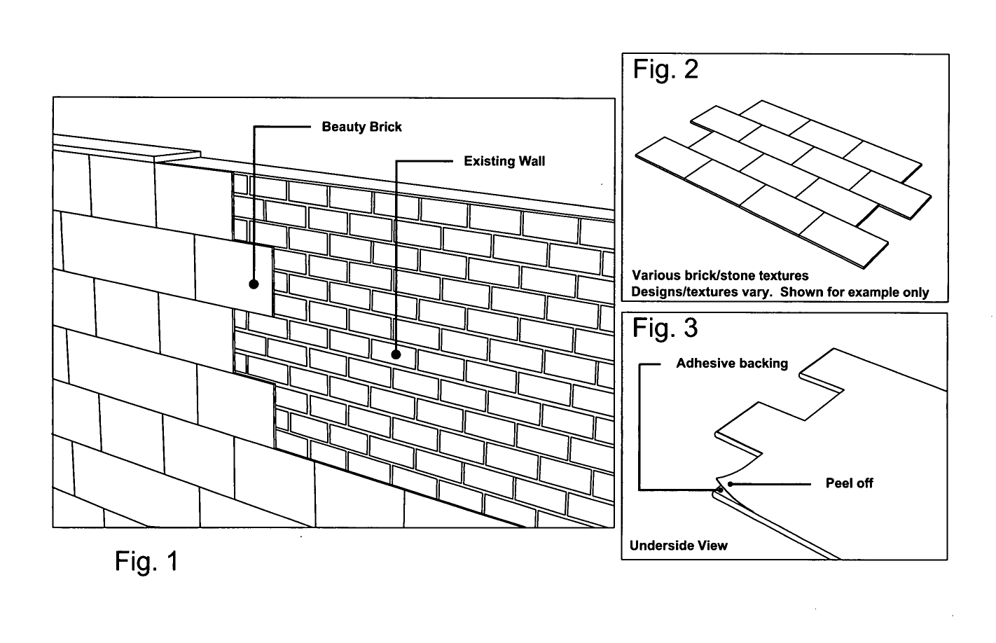

### DETAILED DESCRIPTION OF THE INVENTION

Brick, a block of ceramic material used in masonry construction, is known for its durability and perseverance against the elements. Ever since its first appearance around 7500 BC in Greece, brick has been used for building everything from roads to homes. Many brick walls surrounding kitchen gardens were designed with cavities so hot air could circulate in the winter, warming fruit trees or other produce spread against the walls, causing them to bloom earlier and forcing early fruit production. However, as durable as this stone material can be, brick is not invincible. Particularly, extreme weather may cause degradation of the surface due to frost damage. This type of damage is common with certain types of brick, though relatively rare with concrete block. If non-concrete (clay-based) brick is to be used, care should be taken to select bricks suitable for the climate in question. Masonry must be built upon a firm foundation such as reinforced concrete to avoid potential settling and cracking. If expansive soils such as adobe clay are present, this foundation may need to be quite elaborate and the services of a qualified structural engineer may be required. Additionally, the high weight increases structural requirements, especially in earthquake prone areas. More susceptible to these challenges, exterior brick walls, such as garden walls and those that serve as property boundaries, can begin to crumble over time, lending a neglected appearance to one's property.

This present invention is a line of specially designed, faux brick facades configured to cover existing brick walls, such as those that serve as fencing or property barriers. In this manner, the Beauty Brick provides a simple and inexpensive means of improving the appearance of existing brick. The Beauty Brick line consists of square-shaped sheets comprised of a fiberglass and plastic material that can be applied directly to the surface of bricks, and is available in a wide array of sizes. Pieces with dimensions of approximately 6 feet by 6 feet are standard, and rectangular sections measuring about 6 feet by 8 feet, 6 feet by 10 feet and 6 feet by 12 are offered for fences and walls of varying sizes. Other attributes of the Beauty Brick sheets include a pliability that accommodates facades that are curved or angled.

Additionally, the sheets easily cut to size by the end user. The back of each Beauty Brick sheet features a durable adhesive material that adheres easily to the existing brick surface. Simple in design, application of this product is easy to use. One need only ensure that the existing brick is free of dust, dirt, grease, or paint, and simply apply each Beauty Brick square or rectangle in a desired pattern. To further enhance the appearance of the brick, this line is offered in a variety of styles, from standard red clay to more textured terra-cotta. Effectively covering cracked, damaged and faded bricks that cannot be matched on older fences, the Beauty Brick line quickly and expediently updates old brick walls and makes them look brand new, without having to tear down the brick to build new walls.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A faux brick façade designed to cover existing brick walls, comprising:
embossed sheets comprised of a fiberglass and plastic material that can be applied directly to the surface of bricks, wherein the material is pliable to that accommodate facades that are curved or angled;
durable adhesive material attached to the back side of the sheet.

2. The faux brick façade of claim 1 wherein the sheet is easily cut to size by the end user.

3. The faux brick façade of claim 1, wherein the sheet is approximately six feet in length and six feet in width.

4. The faux brick façade of claim 1 wherein the sheet is approximately six feet in length and eight feet in width.

5. The faux brick façade of claim 1 wherein the sheet is approximately six feet in length and ten feet in width.

6. The faux brick façade of claim 1 wherein the sheet is approximately six feet in length and twelve feet in width.

7. A method of covering an existing brioock wall comprising:
ensuring that the existing brick is free of dust, dirt, grease, or loose paint;
cutting the sheet to fit the size required;
removing the covering of the adhesive backing of the sheet;
pressing the sheet into place.

8. The faux brick façade of claim 1 which is embossed to resemble standard red clay bricks.

9. The faux brick façade of claim 1 embossed to resemble textured terra-cotta.
